(19) United States
(12) Patent Application Publication
(10) Pub. No.: US 2009/0277764 A1
(43) Pub. Date: Nov. 12, 2009

(54) RESETTING MECHANISM FOR LAMP SWITCH WITH OVERCURRENT PROTECTION

(76) Inventor: Ming-Hui Lin, Taichung City (TW)

Correspondence Address: SINORICA, LLC, 2275 Research Blvd., Suite 500, ROCKVILLE, MD, 20850, US

(21) Appl. No.: 12/116,520

(22) Filed: May 7, 2008

(51) Int. Cl. H01H 19/28

(52) U.S. Cl. 200/336

(57) ABSTRACT

A resetting mechanism for lamp switch with overcurrent protection. The resetting mechanism includes a pull switch having a rotary shaft, an overcurrent protection member positioned on one side of the pull switch and a resetting section having a push rod. At least one ratchet is formed on the rotary shaft. The overcurrent protection member includes a conductive section reciprocally movable between an open position and a close position. The push rod of the resetting section is drivable by the ratchet of the rotary shaft to reciprocally move between a reset position and a releasing position. When the rotary shaft rotates, the ratchet pushes the push rod to move from the releasing position to the reset position. In the meantime, the push rod pushes the conductive section from the open position to the close position to recover the power supply circuit from an outage state.

### BACKGROUND OF THE INVENTION

The present invention is related to a ceiling electric appliance, and more particularly to a resetting mechanism for lamp switch with overcurrent protection.

An overcurrent protection device such as a breaker is used to limit current used by an electric appliance to nominal current and protect the electric appliance from overcurrent condition. In the case that the breaker is installed in an electric appliance positioned at a considerable height, such as a ceiling lamp and a ceiling fan, it is difficult for a user to touch and reset the breaker from an open state. In order to overcome such problem, in some cases, the overcurrent protection device of the ceiling electric appliance is installed in a wall switch or electric gate.

A conventional thermally controlled breaker is resettable without human operation. However, such thermally controlled breaker needs a period of time to recover to close state. In case of a lamp, during the recovery, the lamp is unable to provide illuminating effect. This causes inconvenience.

### SUMMARY OF THE INVENTION

It is therefore a primary object of the present invention to provide a resetting mechanism for lamp switch with overcurrent protection. With the resetting mechanism, a user can conveniently reset the overcurrent protection device to recover the power supply circuit from an outage state.

According to the above object, the resetting mechanism for lamp switch with overcurrent protection of the present invention includes a pull switch having a rotary shaft; an overcurrent protection member positioned on one side of the pull switch, the overcurrent protection member including a conductive section reciprocally movable between an open position and a close position in a moving direction, the moving direction of the conductive section and an axis of the rotary shaft containing a predetermined angle, whereby when the conductive section is positioned in the close position, a power supply circuit of the lamp is closed, while when the conductive section is positioned in the open position, the power supply circuit is opened; and a resetting section drivable by the rotary shaft to reciprocally move between a reset position and a releasing position. When the resetting section is moved from the releasing position to the reset position, the resetting section pushes the conductive section from the open position to the close position.

The present invention can be best understood through the following description and accompanying drawings wherein:

### BRIEF DESCRIPTION OF THE DRAWINGS

FIG. 1 is a plane view of the present invention;

FIG. 2 is a perspective exploded view of the present invention;

FIG. 3 is a perspective partially assembled view of the present invention;

FIG. 4 is a perspective exploded view of the present invention, seen by another angle;

FIG. 5 is a perspective assembled view of the present invention, seen by another angle; and

FIG. 6 is a plane view of the present invention, showing the resetting operation thereof.

### DETAILED DESCRIPTION OF THE PREFERRED EMBODIMENTS

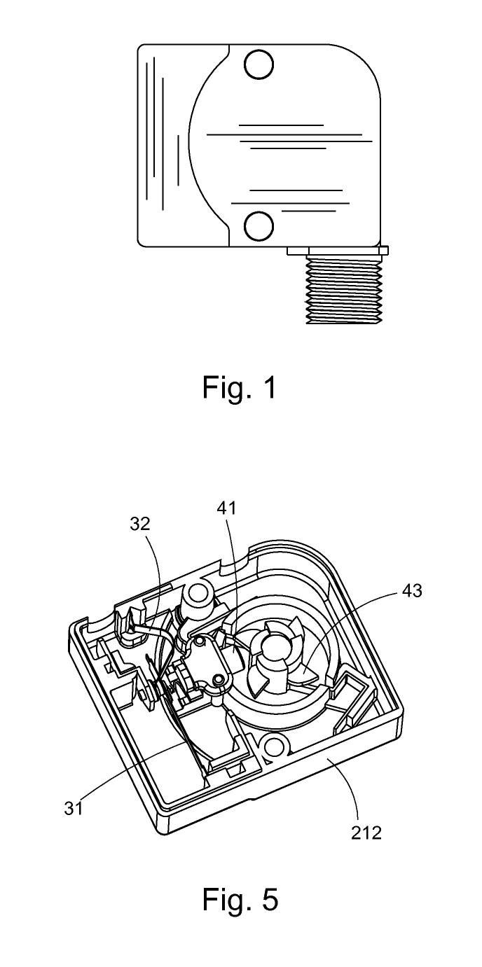

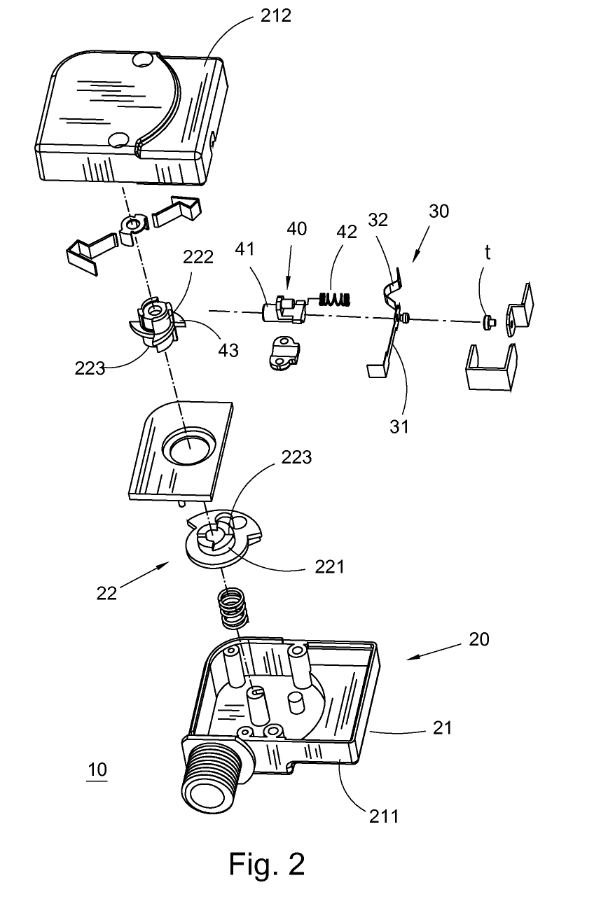

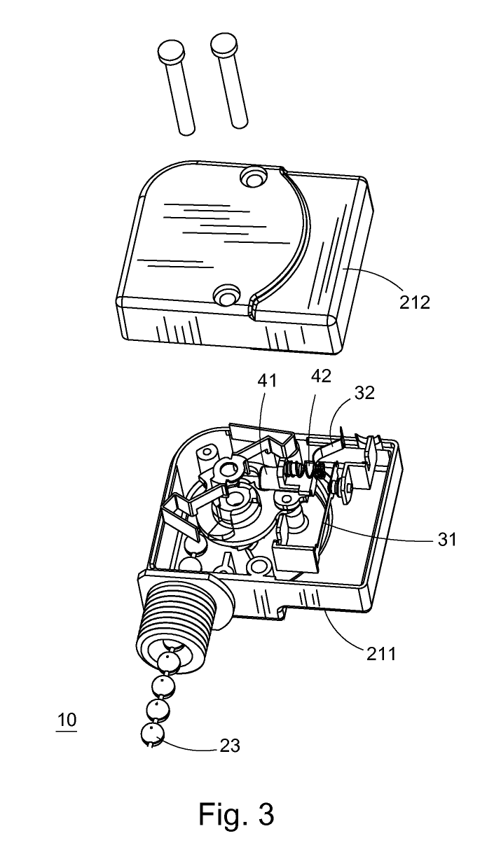

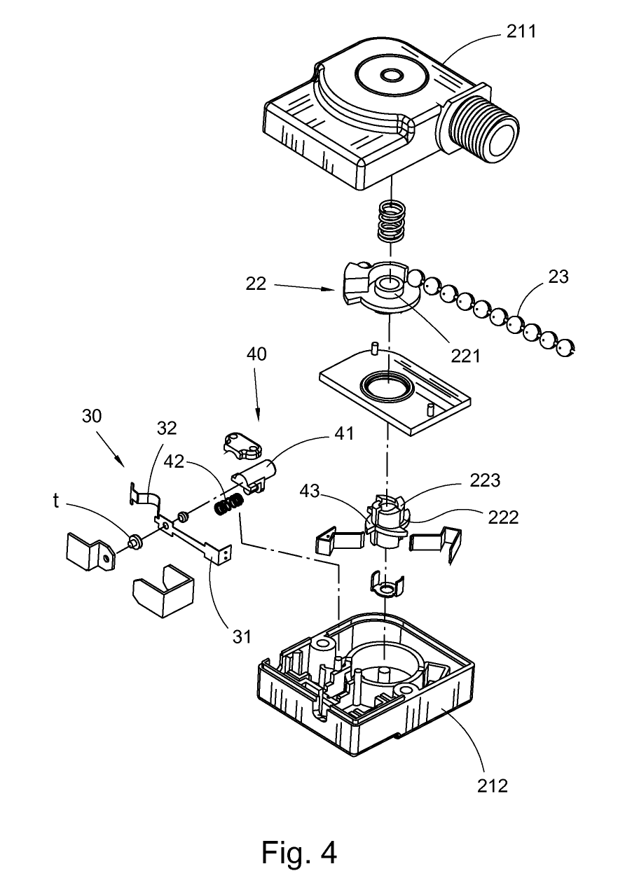

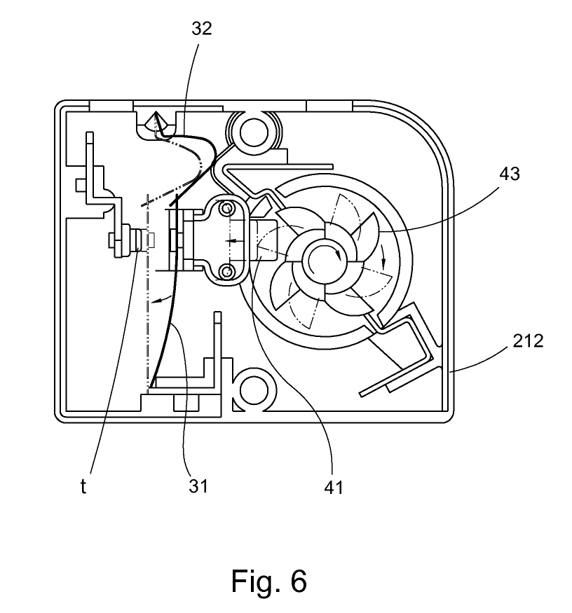

Please refer to FIGS. 1 to 6. The resetting mechanism 10 for lamp switch with overcurrent protection of the present invention includes a pull switch 20, an overcurrent protection member 30 and a resetting section 40.

The pull switch 20 pertains to prior art, including a housing 21 composed of two cases 211, 212 mated with each other. Other components of the present invention are accommodated in the housing 21. A rotary shaft 22 is rotatably mounted in the housing 21. One end of a pull string 23 is connected with the rotary shaft 22. The other end of the pull string 23 is conducted out of an opening of the housing 21 for a user to pull so as to control the lamp. The above arrangements pertain to prior art and thus will not be further described hereinafter. It should be noted that the rotary shaft 22 is composed of a first shaft body 221 and a second shaft body 222 coaxially mated with each other. The first and second shaft bodies 221, 222 respectively have two engaging sections 223 positioned at opposite ends of the first and second shaft bodies 221, 222. The engaging sections 223 are engaged with each other to drivingly connect the first and second shaft bodies 221, 222 with each other.

The overcurrent protection member 30 is received in the housing 21, including a strip-like conductive section 31 with a predetermined length. One end of the conductive section 31 is fixed on the housing 21 electrically in contact with a first contact of a power supply circuit of the lamp. The other end of the conductive section 31 is aligned with a second contact t of the power supply circuit and reciprocally movable between a close position and an open position in a moving direction normal to the axis of the rotary shaft 22. When positioned in the close position, the other end of the conductive section 31 contacts with the second contact t to close the power supply circuit. When positioned in the open position, the other end of the conductive section 31 is separated from the second contact t to open the power supply circuit. One end of a leaf spring 32 is fixed on the housing 21. The other end of the leaf spring 32 is connected with the other end of the conductive section 31 to provide resilience force for locating the conductive section 31 in the close position or the open position.

The resetting section 40 includes a push rod 41 slidably mounted on the housing 21 and reciprocally movable between a reset position and a releasing position in a direction normal to the axis of the rotary shaft 22. One end of the push rod 41 is adjacent to one side of the rotary shaft 22, while the other end of the push rod 41 is directed to the second contact t. The other end of the conductive section 31 is positioned between the push rod 41 and the second contact t. One end of a resilient member 42 abuts against the push rod 41, while the other end of the resilient member 42 abuts against a corresponding section of the housing 21. The resilient member 42 serves to resiliently force the push rod 41 in a direction to the releasing position. Several ratchets 43 are annularly formed on a circumference of the rotary shaft 22 in alignment with one end of the push rod 41. When the rotary shaft 22 rotates, the ratchets 43 are synchronously moved to push the push rod 41 and overcome the resilient force of the resilient member 42. At this time, the push rod 41 is moved from the releasing position to the reset position to push the conductive section 31 from the open position to the close position. At this time, the overcurrent protection member 30 is reset from the open state to the close state.

According to the above arrangement, the overcurrent protection member 30 of the resetting mechanism 10 is reset by means of pulling the pull string 23 of the ceiling electric appliance. Therefore, a user can conveniently pull the pull string 23 to drive the pull switch 20 and rotate the rotary shaft 22. Via the resetting section 40, the overcurrent protection member 30 is reset from the open state to the close state. It is unnecessary for a user to climb high to reset the overcurrent protection member 30. Also, in the case of a lamp, no recovery time is needed and the lamp can quickly provide illuminating effect again.

The above embodiments are only used to illustrate the present invention, not intended to limit the scope thereof. Many modifications of the above embodiments can be made without departing from the spirit of the present invention.

What is claimed is:

1. A resetting mechanism for lamp switch with overcurrent protection, comprising:
a pull switch having a rotary shaft;
an overcurrent protection member positioned on one side of the pull switch, the overcurrent protection member including a conductive section reciprocally movable between an open position and a close position in a moving direction, the moving direction of the conductive section and an axis of the rotary shaft containing a predetermined angle, whereby when the conductive section is positioned in the close position, a power supply circuit of the lamp is closed, while when the conductive section is positioned in the open position, the power supply circuit is opened; and
a resetting section drivable by the rotary shaft to reciprocally move between a reset position and a releasing position, when the resetting section is moved from the releasing position to the reset position, the resetting section pushing the conductive section from the open position to the close position.

2. The resetting mechanism for lamp switch with overcurrent protection as claimed in claim 1, wherein the resetting section includes at least one ratchet formed on a circumference of the rotary shaft, the resetting section further including a push rod having an axis, the axis of the push rod and the axis of the rotary shaft containing a predetermined angle, the push rod being movable between the reset position and the releasing position along the axis of the push rod, one end of the push rod being adjacent to one side of the rotary shaft to abut against the ratchet of the rotary shaft, the resetting section further including a resilient member for resiliently forcing the push rod in a direction to the releasing position, when the rotary shaft rotates, the ratchet pushing the end of the push rod to overcome the resilient force of the resilient member and make the push rod move from the releasing position to the reset position.

3. The resetting mechanism for lamp switch with overcurrent protection as claimed in claim 1, wherein the moving direction of the conductive section is normal to the axis of the rotary shaft.

4. The resetting mechanism for lamp switch with overcurrent protection as claimed in claim 2, wherein the axis of the push rod is normal to the axis of the rotary shaft.

5. The resetting mechanism for lamp switch with overcurrent protection as claimed in claim 1, wherein the rotary shaft is composed of a first shaft body and a second shaft body coaxially mated with each other, the first and second shaft bodies respectively having two engaging sections positioned at opposite ends of the first and second shaft bodies, the engaging sections being engaged with each other to drivingly connect the first and second shaft bodies with each other.

6. The resetting mechanism for lamp switch with overcurrent protection as claimed in claim 1, wherein the conductive section is strip-like, one end of the conductive section being fixed in a certain position electrically in contact with a contact of the power supply circuit of the lamp, the other end of the conductive section being reciprocally movable between the open position and the close position, when positioned in the close position, the other end of the conductive section contacting another contact of the power supply circuit to close the power supply circuit.

7. The resetting mechanism for lamp switch with overcurrent protection as claimed in claim 1, wherein the overcurrent protection member further includes a leaf spring, one end of the leaf spring being fixed in a certain position, the other end of the leaf spring being connected with the other end of the conductive section for resiliently locating the conductive section in the close position or the open position.
